(19) United States
(12) Patent Application Publication
(10) Pub. No.: US 2007/0278384 A1
(43) Pub. Date: Dec. 6, 2007

(54) METHOD AND APPARATUS FOR DRIVING A RADIATION SOURCE

(75) Inventor: Kevin Heppell, Oakland, CA (US)

Correspondence Address: KNOBBE MARTENS OLSON & BEAR LLP, 2040 MAIN STREET, FOURTEENTH FLOOR, IRVINE, CA, 92614, US

(73) Assignee: OPTISCAN BIOMEDICAL CORPORATION, Hayward, CA (US)

(21) Appl. No.: 11/756,574

(22) Filed: May 31, 2007

Related U.S. Application Data
(60) Provisional application No. 60/809,937, filed on Jun. 1, 2006.
(60) Provisional application No. 60/855,059, filed on Oct. 27, 2006.

(51) Int. Cl. G01J 1/32

(52) U.S. Cl. 250/205

(57) ABSTRACT

A method and apparatus are described for driving a modulated radiation source (which can be, for example, an infrared light source). The method affects the power driving a light source in such as way so as to minimize the warm-up time of the source. The apparatus permits feedback control of a light source to specified powers or temperatures. Disclosed embodiments can improve source performance and lifetime and decrease the operating costs of the source.

### CROSS-REFERENCE TO RELATED APPLICATIONS

This application claims the benefit of U.S. Provisional Application No. 60/809,937, filed Jun. 1, 2006, and U.S. Provisional Application No. 60/855,059, filed Oct. 27, 2006. The entirety of each of these applications is hereby incorporated herein by reference and made part of this specification.

### BACKGROUND

1. Field

Described embodiments generally relate to radiation sources and to methods and systems for powering light sources.

2. Description of the Related Art

Existing radiation sources do not always provide a high enough radiative output. Moreover, existing sources are not always stable, and they do not always operate for a long enough period of time without failing. Improvements are also needed in simplicity and cost of manufacture, as well as compatibility with available radiators.

Infrared light is absorbed by many types of organic molecules, and thus infrared light sources are used in a variety of spectroscopic applications. One type of infrared light source includes a resistively-heated element, referred to herein, and without limitation, as a heater element, that emits infrared radiation when resistively heated. Heater elements may be free-standing filaments or thin layers deposited on a substrate. An electric current can be provided to the heater element, which heats up due to the dissipation of electric power within the element.

Heater elements of infrared light sources can be connected to a power source through electrical conductors, such as wires, and may also be in thermal contact with other components of the light source. The connection to the electrical conductors, as well as contact with other components, can act as a conduit for heat (e.g., as a heat sink) to or from the heater element. If the environment is cooler than the peak element temperature, heat flows from the heater element, resulting in a lower element temperature.

The heater element of a resistively-heated infrared light source radiates at a rate that depends, in part, on the heater element temperature. In general, the radiative output and lifetime of a resistively-heated infrared light source depend on the heater element temperature: a higher temperature results in greater radiative output and, usually, a reduced lifetime. As an example, in some sources the radiative output which increases with the fourth power of heater element temperature and the source lifetime decreases exponentially with peak heater element temperature.

Infrared light sources can be modulated by being operated continuously at some duty cycle, for example. For example, a source can be driven by a current that is modulated at a 50% duty cycle. The light source is thus powered half the time and is off the other half. In response to the modulated current, the heater element temperature follows the driving current, with an average power that is half the peak power.

Some light sources are used intermittently—for example, the light is turned on only when needed. The power supplied to the light source cycles between an “on” period of time, when light is needed for some purpose, and an “off” period of time, when no power is provided. The power in the “on” period may be steady or may be a waveform with a repetitive shape, such as a square wave or sine wave. When starting a modulated infrared light source, or when ramping up the power from one average power level to another average power level, the light source output may slowly increase or decrease with time. The unsteady nature of the light source output is problematic when the source is needed for quantitative measurements.

Thus there is a need for a method and apparatus that provides an infrared source that can operate at high radiative output. The method and apparatus preferably can provide stable light output and provide operation for long periods of time without failure. The apparatus is preferably be simple and inexpensive to manufacture and compatible with currently available infrared radiators. Embodiments disclosed herein fulfill some or all of these needs.

### SUMMARY

Certain embodiments provide improved operation of modulated light sources by controlling the power dissipated within the light source during both “on” and “off” periods of time.

Certain embodiments provide a method for operating a light source including providing power to the light source at a first power during a first time period and a second power during a second time period, where the first power is a constant, non-zero power, and where the second power is a non-steady power. The method may further include obtaining a measurement of the light source, where the measurement has a target value, and providing the power to the light source according to a difference between the measurement and the target value.

Certain embodiments provide a method for operating a light source comprising providing power to the light source at a first power during a first time period and a second power during a second time period, where the first power is a constant, non-zero power, where the second power is a non-steady power, and obtaining a measurement of the light source, where the providing compares the measurement with a target value.

Certain embodiments provide an apparatus for operating a light source comprising a circuit to provide power to the light source at a first power during a first time period and a second power during a second time period subsequent to the first time period, where the first power is approximately constant and non-zero, and where the second power is intermittent. The apparatus may further include a sensor to obtain a measurement of the light source; and an electric circuit to control the power according to the measurement.

These features together with the various ancillary provisions and features which will become apparent to those skilled in the art from the following detailed description, can be attained by embodiments shown in the accompanying drawings, by way of example only, wherein:

### BRIEF DESCRIPTION OF THE DRAWINGS

FIG. 1 is a schematic of an infrared light source;

FIG. 2 is a functional schematic diagram of an embodiment of an infrared light source;

FIG. 3 is a schematic wiring diagram of a circuit that operates as a light source of FIG. 1 or 2;

FIG. 4 is one embodiment of a control module of FIG. 3;

FIG. 5 is a sectional schematic illustrating a thermally driven, infrared radiator;

FIG. 6 is a graph illustrating one embodiment of power delivered to an infrared light source as a function of time; and

FIGS. 7 and 8 are graphs illustrating controls to a power supply to provide the power curve of FIG. 6.

Reference symbols are used in the Figures to indicate components, aspects or features shown therein, with reference symbols common to more than one Figure indicating like components, aspects or features shown therein.

### DETAILED DESCRIPTION

Although some preferred embodiments and examples are disclosed below, it will be understood by those skilled in the art that the inventive subject matter extends beyond the specifically disclosed embodiments to other alternative embodiments and/or uses and obvious modifications and equivalents thereof. Thus it is intended that the scope of the inventions herein disclosed should not be limited by the particular disclosed embodiments described below. Thus, for example, in any method or process disclosed herein, the acts or operations making up the method/process may be performed in any suitable sequence, and are not necessarily limited to any particular disclosed sequence. Also, for example, various functions may be performed in one or a combination of devices.

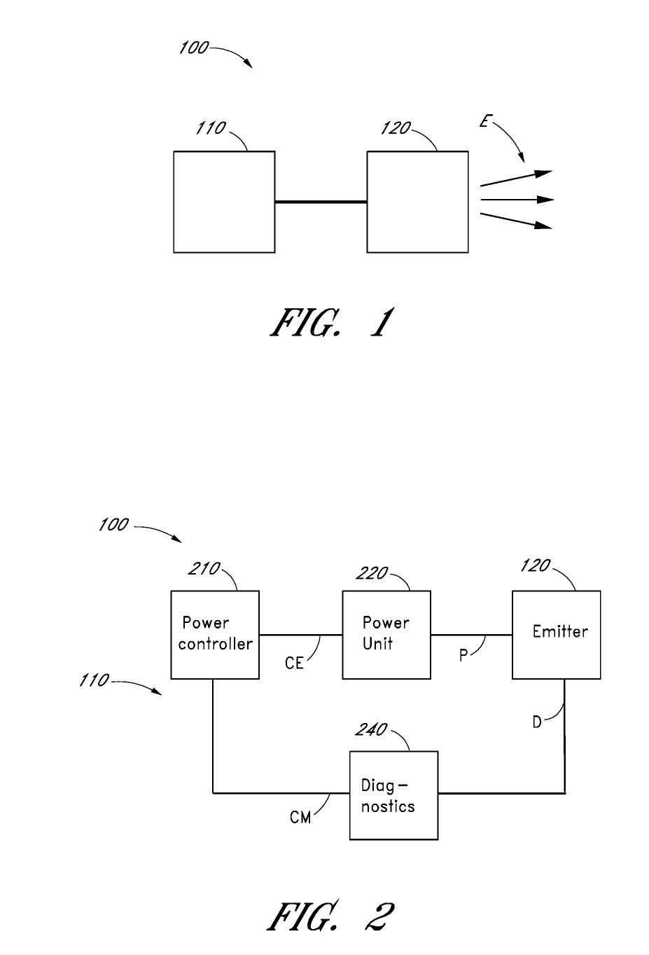

FIG. 1 is one embodiment of a light source 100 that may be operated to generate electromagnetic radiation E. Light source 100 includes a power source 110 that is electrically connected to drive an infrared electromagnetic emitter 120. Electromagnetic radiation E is generated within emitter 120 in response to power source 110—that is, emitter 120 accepts electrical signals from power source 110, and converts the accepted power into electromagnetic radiation E. Electromagnetic radiation E may include, but is not limited to, light in the ultraviolet, visible, and/or infrared portions of the electromagnetic radiation spectrum. In one embodiment, emitter 120 emits electromagnetic radiation E as thermal radiation in proportion to the emitter temperature. Emitter 120 can be, for example, an emitter having a heater element that is resistively heated and which emits according to the instantaneous temperature.

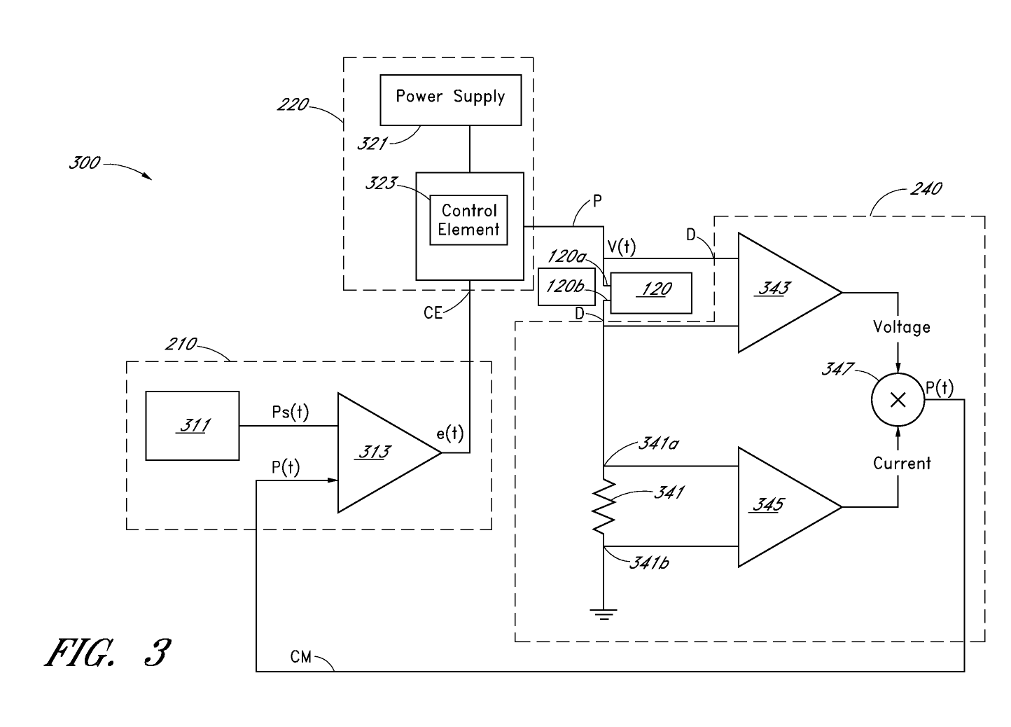

FIG. 2 depicts another embodiment of the light source 100, which may be generally similar to the embodiment illustrated in FIG. 1, except as further detailed below. Where possible, similar elements are identified with identical reference numerals in the depiction of the embodiments of FIGS. 1 and 2.

The light source 100 of FIG. 2 includes a power controller 210, a power unit 220, and an emitter diagnostics 240. Power controller 210, power unit 220 and diagnostics 240 provide a control system for operating emitter 120. In some embodiments, diagnostics 240 measure performance parameters of emitter 120, which may be, but are not limited to, a power dissipated within light source 100 or a temperature measurement of the light source. Diagnostics 240 may include, but is not limited to, circuitry which measures the voltage across and current flowing through emitter 120, thus permitting the dissipated power to be determined, or a thermocouple in thermal contact with the emitter. Power controller 210 compares the measurements to target values, and provides power to emitter 120 to maintain or approach the targeted values.

In some embodiments, diagnostics 240 measures one or more properties related to the operation of emitter 120, and transmits the measures as a control measurement CM to power controller 210. Power controller 210 accepts control measurement CM, compares the value of the control measurement to a target value, and generates a control error CE that is transmitted to power unit 220. Power unit 220 in turn provides an electrical power signal P that drives emitter 120. In some embodiments, light source 100 is controlled to achieve a dissipated power versus time profile. In another embodiment, light source 100 is controlled to achieve a light source temperature.

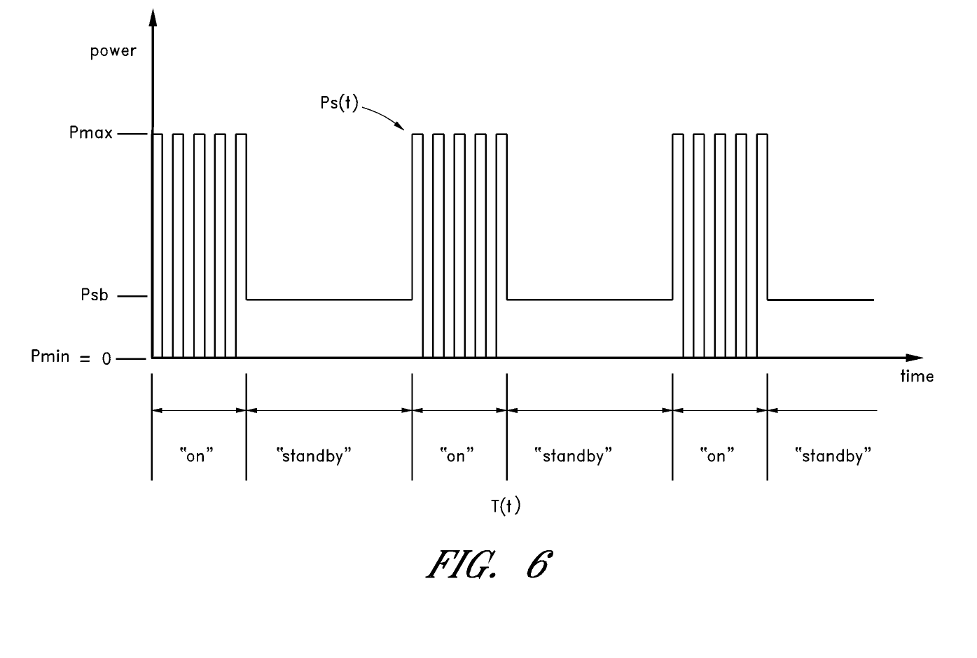

In some embodiments, emitter 120 is an electrical resistance-type radiator. FIG. 5 is a sectional schematic of an electrical resistance-type emitter 520, which may be generally similar to emitter 120, except as further detailed below.

Emitter 520 includes a heater element 521, a housing 523, a support 525, an opening 527, and electrical leads 501 and 503. Heater element 521 is the portion of emitter 520 that emits electromagnetic radiation E, and can be for example, a wire filament, or can be a thin film on a backing. Heater element 521 is supported within housing 532 by support 525, which is either conducting or includes a conducting portion to provide electrical contact with leads 501, 503. Housing 523 provides protection for heater element 521, a structure for mounting emitter 520, and opening 527 to direct radiation from emitter 520. In alternative embodiments, opening 527 has a covering to further protect heater element 521 and which may or may not be shaped to act as a lens to focus electromagnetic radiation E. In use as emitter 120, leads 501, 503 are shown as leads 120a, 120b. Lead 120a is connected to power signal P, and lead 120b is connected, directly or indirectly, to ground.

Heater element 521 can have a low thermal mass (that is, it can heat up rapidly). Housing 523 is in thermal contact with heater element 521 and may affect the operation of emitter 520 by providing a thermal mass and acting as a heat sink for heater element 521. Thus, heat from heater element 521 is transported to housing 523 at a rate that depends on the housing and radiator base temperature. Housing 523 may also affect the operation of emitter 520 by radiating at a temperature that is both different from, and which responds at a different time response than, heater element 521.

Examples of emitter 520 include, but are not limited to, the IR Source manufactured by Axetris, the microsystems division of Leister (Leister Technologies, LLC, Itasca, Ill.) or the pulse IR Emitter manufactured by Boston Electronics Corporation (Brookline, Mass.).

FIG. 3 is a schematic wiring diagram 300 of a circuit that operates as a light source which may be generally similar to light source 100 of FIG. 1 or 2, except as further detailed below. Where possible, similar elements are identified with identical reference numerals in the depiction of the embodiments of FIGS. 1, 2, and 3.

Power controller 210 includes control module 311 and a differential amplifier 313. Power controller 210 accepts a control measurement CM, which is a measure of the electric power P(t) dissipated in emitter 120, which may be an emitter 520, and produces a control error CE, which is a signal e(t) that is used to power the emitter. More specifically, control module 311 generates a signal Ps(t) that is a target for the measured dissipated electric power P(t). The signals Ps(t) and P(t) are provided to differential amplifier 313, which has an output e(t) that is proportional to the difference between the target and measured power, that is:

e(t)=K1(Ps(t)−P(t)), (1)

where K1 is a constant of the differential amplifier 313.

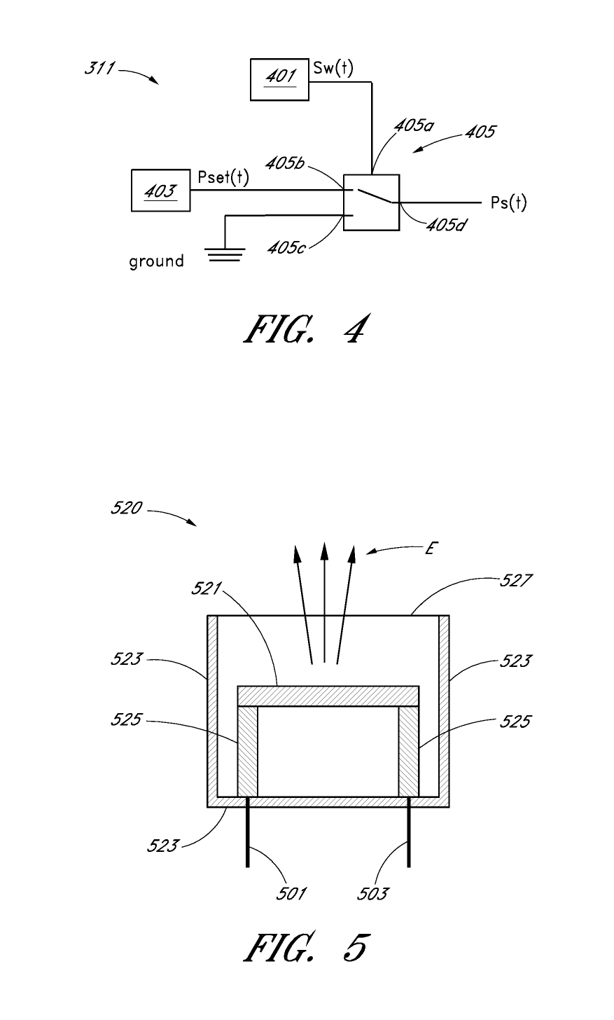

FIG. 4 is one embodiment of a control module 311, which may be generally similar to the embodiment illustrated in FIG. 1, 2, or 3, except as further detailed below. Where possible, similar elements are identified with identical reference numerals in the depiction of the embodiments of FIGS. 1, 2, 3, and 4.

Control module 311 includes a modulation control module 401, a lamp power set point module 403, and a switch 405. Switch 405 is responsive to a control input 405a that connects one of two inputs 405b and 405c with an output 405d. Thus, for example, if input 405b is provided to output 405d for a control input 405a greater than or equal to a voltage Vset, and if input 405c is provided to output 405d for a control input 405a less than a voltage Vset, then the voltage Ps(t) is given by:

$$Ps ( t ) = \{ \begin{matrix}Pset ( t ) , & if Sw ( t ) >= Vset \\ 0 , & if Sw ( t ) < Vset\end{matrix} \qquad ( 2 )$$

With reference to FIG. 3, the control error CE, which may be, for example, the error signal of Equation 1, is provided to power unit 220, which generates a power signal P, such as a time varying voltage V(t). In the embodiment of FIG. 3, power unit 220 includes a power supply 321 and a control element 323. Control element 323 is, but is not limited to, a linear control element, a linear pass transistor, or a modulated switch. Control element 323 accepts the output from power supply 321 and preferably generates a power signal that is directly proportional to the error signal, as V(t)=K2e(t), where K2 is a constant of control element 323. Substituting in Equation 1 gives

V(t)=K1*K2*(Ps(t)−P(t)), (3)

that is, the power signal is proportional to the difference between a desired set point and a measured set point value. Emitter 120 is connected to power signal P and emits electromagnetic radiation E in response the time varying signal V(t).

The embodiment of diagnostics 240 shown in FIG. 3 includes a resistive element 341 having a first end 341a and a second end 341b, operational amplifiers 343 and 345, and a multiplying circuit 347. Diagnostics 240 measures the voltage and current across emitter 120 and multiplies the voltage and current to generate a signal P(t) that is a measure of the power consumption in the emitter, which is the power dissipated in the light source. More specifically, the voltage difference across emitter 120 is provided as input to amplifier 343, generating a signal proportional to the voltage difference. The non-powered lead of emitter 120 is connected to ground through resistive element 341, and the voltage across ends 341a and 341b, provided as input to amplifier 345 generates a signal proportional to the current through emitter 120.

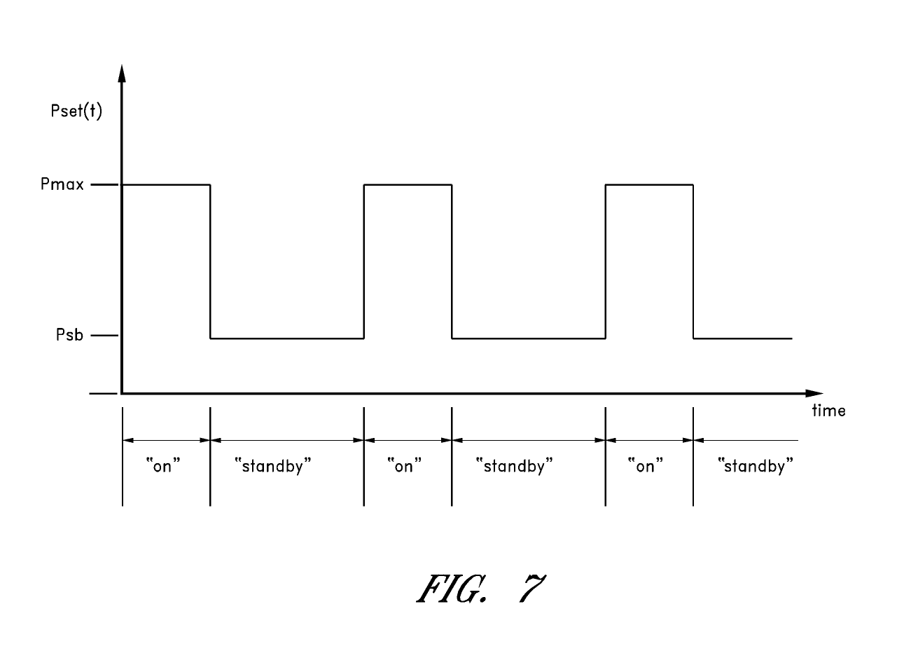

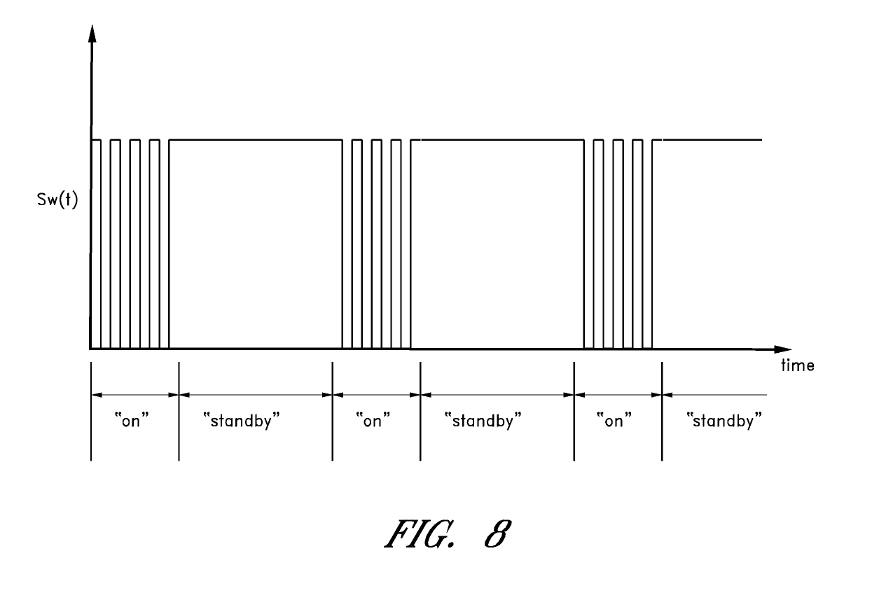

FIG. 6 is a graph of one embodiment of a targeted modulated power for operating a light source 120. The power curve of FIG. 6 may, for example, be obtained by the operation of light source 100, and is a measure, for example, of the power dissipated within light source 120. The power set point Ps(t) fluctuates between an “on” period and a “stand by” period. During the “on” period, Ps(t) is an oscillating, square wave power pulse having amplitude that varies from a minimum value of 0 to a maximum value of Pmax, with a frequency f. In an alternative embodiment, the minimum value is Pmin, which is greater than zero. During the “stand by” period, Ps(t) is a constant value of Psb. The power curve of FIG. 6 can be achieved using light source 100 and the values of Pset(t) shown in FIG. 7 and the values of Sw(t) shown in FIG. 8.

In some embodiments, the effect of the value of Psb can be described as follows. As the value of Psb is increased from zero, fluctuations in the housing temperature will diminish. At a value of Psb that approximately corresponds to an average power dissipation during the “on” period and “stand by” period, the temperature during these two periods will be approximately constant, greatly minimizing temperature variation. Thus, providing power according to FIG. 6 can result in a light source housing temperature that changes little with time. In addition, this results in a heater element that is only operated at peak temperature when needed, and thus also increases the heater element lifetime.

In some embodiments, the values of Psb, Pmax, Pmin, and the “on” and “stand by” periods of time are predetermined such that the average power dissipation within the light source is the same during the “on” and “stand by” time periods, resulting in an approximately constant light source temperature. In another embodiment, the values of Pmax, Pmin, and the “on” and “stand by” periods of time are determined by required energy E, and the value of Psb is selected to minimize the temperature variation of the light source. In yet another embodiment, the value Psb is modified based on temperature measurement of the light source.

Thus, for example, if infrared light is needed for 5 minutes every 15 minutes, then it would be expected that the source lifetime should be at least 3 times longer than if driven continuously at some duty cycle. It has been found that, in practice, the increase in source lifetime greatly exceeds this estimate. One likely explanation is that periodically operating the heater element at a moderate temperature anneals the element or other light source components, reversing damage done during high temperature operation and resulting in a much improved lifetime.

The operation of light source 100 may further be modified to heat the light source from a cold start. Thus, for example, during instrument warm-up, the source can be driven at perhaps 80% of the peak power level with 100% duty cycle to accelerate heating of the source heat sink. The timing of this would have to be determined by experiment.

In addition, if there are one or two wavelengths which are especially sensitive to signal-to-noise, the source may be overdriven during the measurement of those wavelengths as long as the total overdrive time is small compared to the measurement cycle.

In an alternative embodiment, diagnostics 240 includes a thermocouple and associated circuitry for measuring the temperature of a part of emitter 120, and a power controller 210 includes circuitry for maintaining a constant temperature. Thus, for example, in some embodiments, the power controller 210 adjusts Psb so that the “on” and “standby” temperatures are approximately constant.

In yet another alternative embodiment, the light source power is controlled such that an average light source housing temperature including, but not limited to the temperature of housing 523, in an “on” period is the same or approximately equal to the average light source temperature in a “stand by” period. In either case, control can be obtained by measuring either the light source power or housing temperature.

The systems, methods, and devices described above can be used to drive a radiation source in a spectroscopic device, which can be incorporated into a medical device, for example. Thus, in some embodiments, the systems, methods, and devices described above can be used with the devices, systems, and methods described in the context of analyte detection and/or quantification in: U.S. Patent Publication No. 2007/0103678, published May 10, 2007 (Atty. Docket No. OPTIS.150A); U.S. patent application Ser. No. 11/734,261, filed Apr. 11, 2007 (Atty. Docket No. OPTIS.165A); and U.S. Provisional Patent Application No. 60/939,023, filed May 18, 2007 (Atty. Docket No. OPTIS.184PR). The entirety of each of the documents listed in this paragraph is hereby incorporated herein and made part of this specification.

It will be understood that the steps of methods discussed are performed in some embodiments by an appropriate processor (or processors) of a processing (i.e., computer) system executing instructions (code segments) stored in appropriate storage. It will also be understood that the disclosed methods and apparatus are not limited to any particular implementation or programming technique and that the methods and apparatus may be implemented using any appropriate techniques for implementing the functionality described herein. The methods and apparatus are not limited to any particular programming language or operating system. In addition, the various components of the apparatus may be included in a single housing or in multiple housings that communication by wire or wireless communication.

Reference throughout this specification to “one embodiment,” “an embodiment,” or “some embodiments,” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, in the above description of exemplary embodiments, various features of the inventions are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A method for operating a light source comprising:
providing power to the light source at a first power during a first time period and a second power during a second time period,
where said first power is an approximately constant, non-zero power, and
where said second power is a non-steady power.

2. The method of claim 1, where a temperature of the light source is approximately the same during said first time period and during said second time period.

3. The method of claim 1, where said second power is a periodic power having a duty cycle between a maximum power and a minimum power.

4. The method of claim 1, where said light source is an infrared light source.

5. The method of claim 1, where the average power dissipated in the light source during said first time period is approximately equal to the average power dissipated in the light source during said second time period.

6. The method of claim 1, where said light source has a housing having a housing temperature, and where said housing temperature during said first period is approximately equal to said housing temperature during said second period.

7. The method of claim 1, further comprising:
obtaining a measurement of the light source, where said measurement has a target value; and
providing said power to the light source according to a difference between said measurement and said target value.

8. The method of claim 7, where said measurement is a measurement of the temperature of the light source.

9. The method of claim 7, where said measurement is a measurement of the power dissipated in the light source.

10. The method of claim 7, where said providing includes adjusting said first power.

11. A method for operating a light source comprising:
providing power to the light source at a first power during a first time period and a second power during a second time period, where said first power is an approximately constant, non-zero power, where said second power is a non-steady power; and
obtaining a measurement of the light source,
where said providing compares said measurement with a target value.

12. The method of claim 11, where a temperature of the light source is approximately the same during said first time period and during said second time period.

13. The method of claim 11, where said measurement is a measurement of the temperature of the light source, and where said target value is a light source temperature.

14. The method of claim 11, where said measurement is a measurement of the power dissipated in the light source, and where said target value is a target power dissipation value.

15. The method of claim 11, where the electric power during said second time period has a duty cycle between a maximum power and a minimum power.

16. The method of claim 11, where said light source is an infrared light source.

17. An apparatus for operating a light source comprising:
a circuit to provide power to the light source at a first power during a first time period and a second power during a second time period subsequent to said first time period,
where said first power is approximately constant and non-zero, and
where said second power is intermittent.

18. The apparatus of claim 17, where said second power is a periodic power having a duty cycle between a maximum power and a minimum power.

19. The apparatus of claim 17, where said circuit provides said first power during each of a plurality of first time periods, and provides said second power during each of a plurality of second time periods.

20. The apparatus of claim 19, where said second power is a periodic power having a duty cycle between a maximum power and a minimum power.

21. The apparatus of claim 17, where said light source is an infrared light source.

22. The apparatus of claim 17, where said circuit provides power where the power dissipated in the light source during said first time period is approximately equal to the power dissipated during said second time period.

23. The apparatus of claim 17, where said light source includes a housing having a housing temperature, and where said circuit provides power to maintain the housing temperature during said first period approximately equal to said housing temperature during said second period.

24. The apparatus of claim 17, further comprising:
a sensor to obtain a measurement of the light source; and
an electric circuit to control said power according to said measurement.

25. The apparatus of claim 24, where said measurement is a measurement of the temperature of the light source.

26. The apparatus of claim 24, where said measurement is a measurement of the power dissipated in the light source.
